(19) United States
(12) Patent Application Publication
(10) Pub. No.: US 2012/0241688 A1
(43) Pub. Date: Sep. 27, 2012

(54) METHOD FOR PRODUCING LIQUID CRYSTAL POLYESTER COMPOSITION

(75) Inventors: Tomoyuki HARA, Tsukuba-shi (JP); Mitsuo MAEDA, Tsukuba-shi (JP); Yasuo MATSUMI, Tsukuba-shi (JP)

(73) Assignee: SUMITOMO CHEMICAL COMPANY, LIMITED, Tokyo (JP)

(21) Appl. No.: 13/412,810

(22) Filed: Mar. 6, 2012

(30) Foreign Application Priority Data
Mar. 23, 2011 (JP) 2011-064324

(51) Int. Cl. H01B 1/04; B82Y 40/00

(52) U.S. Cl. 252/511; 977/900

(57) ABSTRACT

An object is to provide a method for producing a liquid crystal polyester composition which is excellent in mechanical strength and has semiconductivity. The present invention provides a method for producing a liquid crystal polyester composition, which includes the step of melt-kneading a liquid crystal polyester in the amount of 85 to 99 parts by mass and a nanostructured hollow-carbon material in the amount of 1 to 15 parts by mass, based on 100 parts by mass in total of the liquid crystal polyester and the nanostructured hollow-carbon material, under shear rate of 1,000 to 9,000/second, the nanostructured hollow-carbon material including a carbon part and a hollow part, and having such a structure that a part or all of the hollow part is surrounded by the carbon part.

### BACKGROUND OF THE INVENTION

(1) Field of the Invention

The present invention relates to a method for producing a liquid crystal polyester composition.

(2) Description of the Related Art

A semiconductive resin having a specific volume resistance value of 10⁴ to 10¹² Ωm has been used as materials of a charging roll, a charging belt and a discharging belt in image forming apparatuses such as an electrophotographic copier and an electrostatic storage device; and containers for transporting semiconductor components; by taking advantage of function such as antistatic properties and dust adsorption inhibitory properties.

Examples of the method of imparting semiconductivity to a resin having electrical insulation properties include a method of mixing a resin with conductive substances such as metals, carbon fibers and carbon blacks. It is necessary that a large amount of conductive substances are mixed so as to impart semiconductivity.

On the other hand, a liquid crystal polyester has attracted attention as a material having excellent low hygroscopicity, heat resistance and mechanical strength. Therefore, the liquid crystal polyester has been widely used in applications, for example, electronic precision components such as a connector, films and fibers, and various studies have been made. It is sometimes desired to impart semiconductivity to such a liquid crystal polyester with high utility.

However, there has been such a problem that when an attempt is made to impart semiconductivity to a liquid crystal polyester by a conventional method, mixing of a large amount of a conductive substance causes deterioration of original mechanical strength and moldability of the liquid crystal polyester. There has also been a problem that when a conductive substance has insufficient dispersibility, the obtained liquid crystal polyester composition is less likely to exhibit semiconductivity.

In contrast, disclosed is the technology in which a small amount of a conductive nanostructured hollow-carbon material is added to a liquid crystal polyester (see JP-A-2010-7067 (corresponding to U.S Patent Application Publication No. 2009-0294729)).

### SUMMARY OF THE INVENTION

However, there has not hitherto been known a conventional liquid crystal polyester composition containing a liquid crystal polyester and a nanostructured hollow-carbon material, which is excellent in mechanical strength and has semiconductivity.

In light of the above-mentioned circumstances, the present invention has been made and an object thereof is to provide a method for producing a liquid crystal polyester composition which is excellent in mechanical strength and has semiconductivity.

In order to solve the above-described problem, the present invention provides a method for producing a liquid crystal polyester composition comprising a liquid crystal polyester and a nanostructured hollow-carbon material which satisfies the following requirement (A), the method comprising the step of melt-kneading a liquid crystal polyester in the amount of 85 to 99 parts by mass and a nanostructured hollow-carbon material in the amount of 1 to 15 parts by mass, based on 100 parts by mass in total of the liquid crystal polyester and the nanostructured hollow-carbon material, under shear rate of 1,000 to 9,000/second: (A) the nanostructured hollow-carbon material includes a carbon part and a hollow part, and has such a structure that a part or all of the hollow part is surrounded by the carbon part.

According to the present invention, it is possible to provide a method for producing a liquid crystal polyester composition which is excellent in mechanical strength and has semiconductivity.

### DETAILED DESCRIPTION OF PREFERRED EMBODIMENTS

The liquid crystal polyester in the present invention is a liquid crystal polyester which exhibits mesomorphism in a molten state, and is preferably melted at a temperature of 450° C. or lower. The liquid crystal polyester may also be a liquid crystal polyester amide, a liquid crystal polyester ether, a liquid crystal polyester carbonate, or a liquid crystal polyester imide. The liquid crystal polyester is preferably a whole aromatic liquid crystal polyester in which only an aromatic compound is used as a raw monomer.

Typical examples of the liquid crystal polyester include (I) a liquid crystal polyester obtained by polymerizing (polycondensing) an aromatic hydroxycarboxylic acid, an aromatic dicarboxylic acid, and at least one compound selected from the group consisting of an aromatic diol, an aromatic hydroxyamine and an aromatic diamine; (II) a liquid crystal polyester obtained by polymerizing plural kinds of aromatic hydroxycarboxylic acids; (III) a liquid crystal polyester obtained by polymerizing an aromatic dicarboxylic acid with at least one compound selected from the group consisting of an aromatic diol, an aromatic hydroxyamine and an aromatic diamine; and (IV) a liquid crystal polyester obtained by polymerizing a polyester such as polyethylene terephthalate with an aromatic hydroxycarboxylic acid. Herein, a part or all of an aromatic hydroxycarboxylic acid, an aromatic dicarboxylic acid, an aromatic diol, an aromatic hydroxyamine and an aromatic diamine may be changed, respectively independently, to a polymerizable derivative thereof.

Examples of the polymerizable derivative of the compound having a carboxyl group, such as an aromatic hydroxycarboxylic acid and an aromatic dicarboxylic acid include a derivative (ester) in which a carboxyl group is converted into an alkoxycarbonyl group or an aryloxycarbonyl group; a derivative (acid halide) in which a carboxyl group is converted into a haloformyl group, and a derivative (acid anhydride) in which a carboxyl group is converted into an acyloxycarbonyl group.

Examples of the polymerizable derivative of the compound having a hydroxyl group, such as an aromatic hydroxycarboxylic acid, an aromatic diol and an aromatic hydroxylamine include a derivative (acylate) in which a hydroxyl group is converted into an acyloxyl group by acylation.

Examples of the polymerizable derivative of the compound having an amino group, such as an aromatic hydroxyamine and an aromatic diamine include a derivative (acylate) in which an amino group is converted into an acylamino group by acylation.

The liquid crystal polyester preferably includes a repeating unit represented by the following general formula (1) (hereinafter referred to as a “repeating unit (1)”), and more preferably includes a repeating unit (1), a repeating unit represented by the following general formula (2) (hereinafter referred to as a “repeating unit (2)”), and a repeating unit represented by the following general formula (3) (hereinafter referred to as a “repeating unit (3)”)

—O—Ar¹—CO— (1)

—CO—Ar²—CO— (2)

—X—Ar³—Y— (3)

—Ar⁴—Z—Ar⁵— (4)

wherein Ar¹ is a phenylene group, a naphthylene group or a biphenylene group; Ar² and Ar³ each independently represents a phenylene group, a naphthylene group, a biphenylene group or the above formula (4); X and Y each independently represents an oxygen atom or an imino group; Ar⁴ and Ar⁵ each independently represents a phenylene group or a naphthylene group; Z is an oxygen atom, a sulfur atom, a carbonyl group, a sulfonyl group or an alkylidene group; and one or more hydrogen atoms in Ar¹, Ar² or Ar³ each independently may be substituted with a halogen atom, an alkyl group or an aryl group.

Examples of the halogen atom include a fluorine atom, a chlorine atom, a bromine atom and an iodine atom.

Examples of the alkyl group include a methyl group, an ethyl group, a n-propyl group, an isopropyl group, a n-butyl group, an isobutyl group, a sec-butyl group, a tert-butyl group, a n-pentyl group, a n-hexyl group, a n-heptyl group, a 2-ethylhexyl group, a n-octyl group, a n-nonyl group and n-decyl group, and the number of carbon atoms is preferably from 1 to 10.

Examples of the aryl group include a phenyl group, an o-tolyl group, a m-tolyl group, a p-tolyl group, 1-naphthyl group and a 2-naphthyl group, and the number of carbon atoms is preferably from 6 to 20.

When the hydrogen atom is substituted with these groups, the number thereof is preferably 2 or less, and more preferably 1, every group represented by Ar¹, Ar² or Ar³, respectively, independently.

Examples of the alkylidene group include a methylene group, an ethylidene group, an isopropylidene group, a n-butylidene group and a 2-ethylhexylidene group, and the number of carbon atoms is preferably from 1 to 10. The repeating unit (1) is a repeating unit derived from an aromatic hydroxycarboxylic acid. The repeating unit (1) is preferably a repeating unit derived from p-hydroxybenzoic acid (Ar¹ is a p-phenylene group), or a repeating unit derived from 6-hydroxy-2-naphthoic acid (Ar¹ is a 2,6-naphthylene group).

The repeating unit (2) is a repeating unit derived from an aromatic dicarboxylic acid. The repeating unit (2) is preferably a repeating unit derived from terephthalic acid (Ar² is a p-phenylene group), a repeating unit derived from isophthalic acid (Ar² is a m-phenylene group), a repeating unit derived from 2,6-naphthalenedicarboxylic acid (Ar² is a 2,6-naphthylene group), or a repeating unit derived from diphenylether-4,4′-dicarboxylic acid (Ar² is a diphenylether-4,4′-diyl group).

The repeating unit (3) is a repeating unit derived from an aromatic diol, an aromatic hydroxylamine or an aromatic diamine. The repeating unit (3) is preferably a repeating unit derived from hydroquinone, p-aminophenol or p-phenylenediamine (Ar³ is a p-phenylene group), or a repeating unit derived from 4,4′-dihydroxybiphenyl, 4-amino-4′-hydroxybiphenyl or 4,4′-diaminobiphenyl (Ar³ is a 4,4′-biphenylene group).

The content of the repeating unit (1) is preferably 30 mol % or more, more preferably 30 to 80 mol %, still more preferably 40 to 70 mol %, and particularly preferably 45 to 65 mol %, based on the total amount of the whole repeating unit constituting the liquid crystal polyester (value in which the mass of each repeating unit constituting a liquid crystal polyester is divided by the formula weight of each repeating unit to obtain an amount (mol) equivalent to the amount of a substance of each repeating unit, and then masses thus obtained are totalized). The content of the repeating unit (2) is preferably 35 mol % or less, more preferably from 10 to 35 mol %, still more preferably from 15 to 30 mol %, and particularly preferably from 17.5 to 27.5 mol %, based on the total amount of the whole repeating unit constituting the liquid crystal polyester. The content of the repeating unit (3) is preferably 35 mol % or less, more preferably from 10 to 35 mol %, still more preferably from 15 to 30 mol %, and particularly preferably from 17.5 to 27.5 mol %, based on the total amount of the whole repeating unit constituting the liquid crystal polyester. As the content of the repeating unit (1) increases, melt fluidity, heat resistance, strength and rigidity are likely to be improved. However, when the content is too large, melting temperature and melt viscosity are likely to increase and the temperature required to molding is likely to increase.

A ratio of the content of the repeating unit (2) to the content of the repeating unit (3) [content of the repeating unit (2)]/[content of the repeating unit (3)] is preferably from 0.9/1 to 1/0.9, more preferably from 0.95/1 to 1/0.95, and still more preferably from 0.98/1 to 1/0.98.

The liquid crystal polyester may include two or more kinds of repeating units (1) to (3), respectively independently. The liquid crystal polyester may include repeating units other than repeating units (1) to (3), and the content thereof is preferably 10 mol % or less, and more preferably 5 mol % or less, based on the total amount of the whole repeating unit constituting the liquid crystal polyester.

From the viewpoint of the fact that melt viscosity of the liquid crystal polyester is likely to decrease, the liquid crystal polyester preferably includes, as the repeating unit (3), a repeating unit in which X and Y are respectively oxygen atoms, that is, a repeating unit derived from an aromatic diol, and more preferably includes, as the repeating unit (3), only a repeating unit in which X and Y are respectively oxygen atoms.

The liquid crystal polyester is preferably produced by melt-polymerizing a raw compound (monomer) to obtain a polymer (prepolymer), and then subjecting the obtained prepolymer to solid phase polymerization. Whereby, it is possible to produce a high molecular weight liquid crystal polyester having heat resistance as well as high strength and rigidity with satisfactory operability. The melt polymerization may be performed in the presence of a catalyst. In this case, examples of the catalyst include metal compounds such as magnesium acetate, stannous acetate, tetrabutyl titanate, lead acetate, sodium acetate, potassium acetate and antimony trioxide; and nitrogen-containing heterocyclic compounds such as 4-(dimethylamino)pyridine and 1-methylimidazole. Among them, nitrogen-containing heterocyclic compounds are preferably used.

The flow initiation temperature of the liquid crystal polyester is preferably 270° C. or higher, more preferably from 270° C. to 400° C., and still more preferably from 280° C. to 380° C. As the flow initiation temperature increases, heat resistance, strength and rigidity are likely to be improved. When the flow initiation temperature is too high, melting temperature and melt viscosity are likely to increase and the temperature required to molding is likely to increase.

The flow initiation temperature is also called a flow temperature and means a temperature at which a melt viscosity is 4,800 Pa·s (48,000 poise) when a liquid crystal polyester is melted while raising a temperature at a heating rate of 4° C./rain under a load of 9.8 MPa (100 kg/cm²) and extruded through a nozzle having an inner diameter of 1 mm and a length of 10 mm using a capillary rheometer, and the flow initiation temperature serves as an index indicating a molecular weight of the liquid crystal polyester (see “Liquid Crystalline Polymer Synthesis, Molding, and Application” edited by Naoyuki Koide, page 95, published by CMC on Jun. 5, 1987).

In the present invention, the nanostructured hollow-carbon material has a nanosize (for example, the outer diameter is from about 0.5 nm to 1 μm) and includes a carbon part and a hollow part, and also satisfies the above-mentioned requirement (A).

Examples of the structure according to the requirement (A) include (1) a structure in which a part or all of a hollow part is surrounded by a uniform carbon part, and (2) a structure in which a part or all of a hollow part is surrounded by a non-uniform carbon part (that is, a carbon part formed by connecting a plurality of carbon parts, or a massive carbon part formed of a plurality of carbon parts).

In order to further enhance the effects of the present invention, it is preferred that the nanostructured hollow-carbon material further satisfies the following requirements (B) and (C):

(B) a carbon part of the nanostructured hollow-carbon material has a thickness within a range from 1 to 100 nm; and
(C) a hollow part of the nanostructured hollow-carbon material has a diameter within a range from 0.5 to 90 nm.

In the present invention, the carbon'part of the nanostructured hollow-carbon material may have a multilayered structure and satisfies, for example, the following requirement (D):

(D) the carbon part of the nanostructured hollow-carbon material has a multilayered structure composed of 2 to 200 layers (preferably 2 to 100 layers in view of the production).

In the present invention, the nanostructured hollow-carbon material is preferably obtained by a method comprising the following steps (1), (2), (3) and (4) in this order:

(1) step of producing template catalyst nanoparticles;
(2) step of polymerizing a carbon material precursor in the presence of template catalyst nanoparticles to form a carbon material intermediate on a surface of template catalyst nanoparticles;
(3) step of carbonizing the carbon material intermediate formed on the surface of template catalyst nanoparticles to produce a nanostructured composite material; and
(4) step of removing template catalyst nanoparticles from the nanostructured composite material to produce a nanostructured hollow-carbon material.

In step (1), template catalyst nanoparticles are produced as follows.

One or more catalyst precursors and one or more dispersing agent are reacted or bonded to form a catalyst composite. In general, the catalyst precursor and the dispersing agent are dissolved in an appropriate solvent to prepare a catalyst solution, or are dispersed therein to prepare a catalyst suspension, and the catalyst precursor and the dispersing agent are bonded to form a catalyst composite.

There is no particular limitation on the catalyst precursor, as long as it promotes polymerization of the carbon material precursor and/or carbonization of the carbon material intermediate described below, and the catalyst precursor may preferably be a transition metal such as iron, cobalt, and nickel, and more preferably iron.

The dispersing agent is selected from substances capable of promoting the production of template catalyst nanoparticles having the objective stability, size and uniformity. Examples of the dispersing agent include substances such as various organic molecules, polymers and oligomers. The dispersing agent is dissolved or dispersed in an appropriate solvent when used.

The solvent is used for the purpose of an interaction between the catalyst precursor and the dispersing agent, and the solvent may not only function merely as a solvent, but also function as a dispersing agent, or may be those which allow the produced template catalyst nanoparticles to be suspended. There is no particular limitation on the solvent, and examples of the preferred solvent include water; organic solvents such as methanol, ethanol, 1-propanol, 2-propanol, acetonitrile, acetone, tetrahydrofuran, ethylene glycol, dimethylformamide, dimethyl sulfoxide and methylene chloride; and a combination of two or more kinds of these solvents.

The catalyst composite is considered to be a composite of the catalyst precursor and the dispersing agent surrounded by solvent molecules. A dried catalyst composite can be obtained by producing a catalyst composite in the catalyst solution or the catalyst suspension, and removing the solvent using an operation such as drying. The dried catalyst composite can be returned to a suspension by adding an appropriate solvent.

It is possible to control a molar ratio of the dispersing agent to the catalyst precursor contained in the catalyst solution or catalyst suspension. The molar ratio of the catalyst atom to the functional group contained in the dispersing agent is preferably from 0.01:1 to 100:1, and more preferably from 0.05:1 to 50:1.

The dispersing agent can promote formation of template catalyst nanoparticles having very small and uniform particle diameter. In general, template catalyst nanoparticles are formed in the size of 1 μm or less in the presence of a dispersing agent, and this size is preferably 50 nm or less, and more preferably 20 nm or less.

Additives for promoting the formation of template catalyst nanoparticles may be added to the catalyst solution or catalyst suspension. Examples of the additives include an inorganic acid and a base compound. Examples of the inorganic acid include hydrochloric acid, nitric acid, sulfuric acid and phosphoric acid, and examples of the base compound include inorganic base compounds such as sodium hydroxide, potassium hydroxide, calcium hydroxide and ammonium hydroxide. An aqueous solution of basic substances such as ammonia may be added to the catalyst solution or catalyst suspension so as to adjust the pH value within a range from 8 to 13. In this case, the pH value is preferably adjusted within a range from 10 to 11. The pH value of the catalyst solution or catalyst suspension exerts an influence on the particle diameter of template catalyst nanoparticles. For example, when the pH value is more than 13, the catalyst precursor is finely separated.

Also, a solid substance for promoting the formation of template catalyst nanoparticles may be added to the catalyst solution or catalyst suspension. For example, an ion exchange resin as the solid substance can be added at the time of formation of template catalyst nanoparticles. The solid substance can be removed from a final catalyst solution or catalyst suspension by a well-known simple operation.

Typically, the template catalyst nanoparticles can be obtained by stirring the catalyst solution or catalyst suspension for 0.5 hours to 14 days. The temperature at the time of stirring is preferably from 0 to 200° C. The temperature is an important factor which exerts an influence on the particle diameter of template catalyst nanoparticles.

For example, when using iron as the catalyst precursor, iron becomes iron compounds such as iron chloride, iron nitrate and iron sulfate, and template catalyst nanoparticles are formed by reacting or bonding the iron compounds with the dispersing agent. These iron compounds may be often dissolved in a water-based solvent. When template catalyst nanoparticles are formed using metal such as iron, a by-product is generated. Typical examples of the by-product include a hydrogen gas. Typically, template catalyst nanoparticles are activated in the above-mentioned mixing step, or activated by reducing using hydrogen.

Preferably, the template catalyst nanoparticles are formed as a suspension of metal catalyst nanoparticles which are chemically stable and have high catalytic activity. When the template catalyst nanoparticles are stable, coagulation of particles is suppressed. Even if a part or all of the template catalyst nanoparticles are sedimented, the particles are easily re-suspended by mixing with the sediment.

The template catalyst nanoparticles have a role as a catalyst of promoting polymerization of the carbon material precursor in step (2), and a catalyst of promoting carbonization of the carbon material intermediate in step (3). The diameter of the template catalyst nanoparticles exerts an influence on the diameter of the hollow part of the nanostructured hollow-carbon material produced in step (4).

In step (2), a carbon material intermediate is formed on a surface of template catalyst nanoparticles by dispersing template catalyst nanoparticles in a carbon material precursor, followed by polymerization. There is no particular limitation on the carbon material precursor, as long as it enables template catalyst nanoparticles to be dispersed therein, and examples of a preferred organic material include a benzene or naphthalene derivative having one or more aromatic rings and a polymerizable functional group in a molecule. Examples of the polymerizable functional group include groups such as “—COOH”, “—C(═O)—”, “—OH”, “—C═C—”, “—S(═O)₂—”, “—NH₂”, “—SOH” and “—N═C═O”.

Preferred examples of the carbon material precursor include substances such as resorcinol, a phenol resin, a melanin-formaldehyde gel, a resorcinol-formaldehyde gel, polyfurfuryl alcohol, polyacrylonitrile, a sugar and a petroleum pitch.

The template catalyst nanoparticles are mixed with the carbon material precursor so as to polymerize the carbon material precursor on the surface. Since the template catalyst nanoparticles have polymerization catalytic activity, initiation and proceeding of the polymerization of the carbon material precursor occur in the vicinity of the particles.

The use amount of the carbon material precursor to the template catalyst nanoparticles can be set so that a maximum amount of a carbon material intermediate is uniformly formed on the surface of the template catalyst nanoparticles. The use amount of the template catalyst nanoparticles is preferably adjusted depending on the kind of the carbon material precursor. In the present invention, a molar ratio of the carbon material precursor to the template catalyst nanoparticles (carbon material precursor:template catalyst nanoparticles) is preferably from 0.1:1 to 100:1, and more preferably from 1:1 to 30:1. The molar ratio, the kind and particle diameter of the template catalyst nanoparticles exert an influence on a thickness of the carbon part in the below-mentioned nanostructured hollow-carbon material.

It is preferred that the mixture of the template catalyst nanoparticles and the carbon material precursor is sufficiently polymerized until the carbon material intermediate is sufficiently formed on the surfaces of the template catalyst nanoparticles. A period of time required for forming the carbon material intermediate depends on the polymerization temperature, kind and concentration of the template catalyst, pH of the mixed solution, and kind of the carbon material precursor to be used.

By adding ammonia for adjusting the pH of the mixture of the template catalyst nanoparticles and the carbon material precursor, a rate of polymerization of the carbon material precursor is increased and the amount of a cross-linking reaction between the carbon material precursors can be increased, and thus the polymerization can be sometimes effectively performed. With respect to the carbon material precursor which is polymerizable by heat, the polymerization usually proceeds smoothly as the temperature increases. In this case, the polymerization temperature is preferably from 0 to 200° C., and more preferably from 25 to 120° C. Regarding optimum polymerization conditions of a resorcinol-formaldehyde gel as the carbon material precursor, when iron particles are used as the catalyst precursor and the pH of the suspension is from 1 to 14, the polymerization temperature is 0 to 90° C. and the polymerization time is from 1 to 72 hours.

The thickness of the carbon parts of the below-mentioned nanostructured hollow-carbon material can be controlled by adjusting the degree of proceeding of the polymerization of the carbon material precursor.

In step (3), the nanostructured composite material is obtained by carbonizing the carbon material intermediate. The carbonization is usually performed by firing, and, typically, the firing is performed at a temperature of 500 to 2,500° C. During the firing, oxygen atoms and nitrogen atoms contained in the carbon material intermediate are released to cause re-alignment of the carbon atoms, thereby forming a carbide. Preferred carbide has a graphite-like layered structure (multilayered structure) and the thickness of the layered structure is preferably from 1 to 100 nm, and more preferably from 1 to 20 nm. The number of layers can be controlled by the kind, thickness and firing temperature of the carbon material intermediate. The thickness of the carbon parts of the below-mentioned nanostructured hollow-carbon material can also be controlled by adjusting the degree of proceeding of the carbonization of the carbon material intermediate.

In step (4), the template catalyst nanoparticles are removed from the nanostructured composite material to obtain the nanostructured hollow-carbon material. The removal of the template catalyst nanoparticles may be performed by the method which does not completely break a nano-hollow structure or a nano-ring structure in the nanostructured composite material, and can be typically performed by bringing the nanostructured composite material into contact with an acid or a base, such as nitric acid, a hydrofluoric acid solution, and sodium hydroxide. It is particularly preferred to bring the nanostructured composite material into contact with nitric acid (for example, 5N nitric acid). The contact treatment is performed by refluxing for 3 to 10 hours.

The nanostructured hollow-carbon material is specific in shape, size and electrical properties. Examples of typical shape (structure) include a particle-shaped structure including a hollow part, a bag-shaped structure, a structure including at least a part of these structures, and an assembly structure of these structures. The particle-shaped structure preferably has a generally spherical external form. Examples of the bag-shaped structure include only one structure including a site (opening) at which the hollow part is opened in the particle-shaped structure.

In step (3), since a carbide is formed on a surface of the template catalyst nanoparticles, the shape and particle diameter of the obtained nanostructured hollow-carbon material, and the shape and diameter of the hollow part largely depends on the shape and size of the template catalyst nanoparticles used in step (1).

The following properties (1) to (4) of the nanostructured hollow-carbon material can be measured by a transmission electron microscope:

(1) shape and particle diameter;

(2) number of layers in case where the carbon part has a multilayered structure;

(3) thickness of the carbon part; and

(4) shape and diameter of the hollow part.

In the melt-kneading step according to the present invention, the liquid crystal polyester is used in the amount within a range from 85 to 99 parts by mass, and preferably from 90 to 96 parts by mass, based on 100 parts by mass in total of the liquid crystal polyester and the nanostructured hollow-carbon material, while the nanostructured hollow-carbon material is used in the amount within a range from 1 to 15 parts by mass, and preferably from 4 to 10 parts by mass. When the amount of the liquid crystal polyester is more than 99 parts by mass (the amount of the nanostructured hollow-carbon material is less than 1 part by mass), the obtained composition may have insufficient conductivity. When the amount of the liquid crystal polyester is less than 85 parts by mass (the amount of the nanostructured hollow-carbon material is more than 15 parts by mass), the obtained composition may have insufficient mechanical strength and moldability.

The liquid crystal polyester composition obtained by the present invention may optionally contain, in addition to the liquid crystal polyester and the nanostructured hollow-carbon material, one or more kinds of other components such as a filler, an additive, and a resin other than a liquid crystal polyester.

The filler may be a fiber-shaped filler, a plate-shaped filler, or a filler other than the above fillers, such as a spherical particle-shaped filler. The filler may be an inorganic filler or an organic filler. Examples of the fiber-shaped inorganic filler include glass fibers; carbon fibers such as a PAN-based carbon fiber and a pitch-based carbon fiber; ceramic fibers such as a silica fiber, an alumina fiber and a silica alumina fiber; metal fibers such as a stainless steel fiber; and whiskers such as a potassium titanate whisker, a barium titanate whisker, a wollastonite whisker, an aluminum borate whisker, a silicon nitride whisker and a silicon carbide whisker. Examples of the fiber-shaped organic filler include a polyester fiber and an aramid fiber. Examples of the plate-shaped inorganic filler include talc, mica, graphite, wollastonite, glass flake, barium sulfate and calcium carbonate. The mica may be any of muscovite, phlogopite, fluorphlogopite and tetrasilicic mica. Examples of the particle-shaped inorganic filler include silica, alumina, titanium oxide, glass beads, glass balloon, boron nitride, silicon carbide and calcium carbonate. The content of the filler in the liquid crystal polyester composition is preferably from 0 to 100 parts by mass based on 100 parts by mass of the liquid crystal polyester.

Examples of the additive include a leveling agent, a defoamer, an antioxidant, a heat stabilizer, an ultraviolet absorber, an antistatic agent, a surfactant, a flame retardant and a colorant. The content of the additive in the liquid crystal polyester composition is preferably from 0 to 5 parts by mass based on 100 parts by mass of the liquid crystal polymer.

Examples of the resin other than the liquid crystal polymer include thermoplastic resins such as polypropylene, polyester other than a liquid crystal polyester, polyphenylene sulfide, polyetherketone, polycarbonate, polyphenylene ether and polyetherimide; and thermosetting resins such as a phenol resin, an epoxy resin, a polyimide resin and a cyanate resin. The content of the resin other than the liquid crystal polyester in the liquid crystal polyester composition is preferably from 0 to 20 parts by mass based on 100 parts by mass of the liquid crystal polyester.

In the present invention, it is possible to obtain a composition having excellent conductivity, which contains a nanostructured hollow-carbon material dispersed therein, by melt-kneading the liquid crystal polyester with the nanostructured hollow-carbon material at a high shear rate within a range from 1,000 to 9,000/second, preferably from 1,000 to 5,000/second, and more preferably 1,000 to 3,000/second. When the shear rate is less than 1,000/second, the nanostructured hollow-carbon material may not be sufficiently dispersed. In contrast, when the shear rate is more than 5,000/second, the liquid crystal polyester may cause heat deterioration.

In the present invention, it is considered that a composition having semiconductivity can be obtained even in the case of a small use amount of the nanostructured hollow-carbon material based on the following reasons: the nanostructured hollow-carbon material: (1) is likely to be dispersed as compared with a carbon material such as a carbon nanotube, and (2) is sufficiently dispersed by melt-kneading at a high shear rate.

The melt-kneading temperature may be appropriately adjusted according to the kind of the liquid crystal polyester and the nanostructured hollow-carbon material, and is preferably from 250 to 400° C., more preferably from 270 to 400° C., and still more preferably from 280 to 380° C.

Melt-kneading according to the present invention can be performed by using a high shear type kneader which enables extrusion molding such as nanocompounding that could not be performed by a conventional twin-screw extruder. Examples of the kneader include a complete engagement type same direction rotation four-screw extruder (for example, “KZW FR”, manufactured by Technovel Corporation), and a high shear molding machine equipped with a feedback screw (for example, “NHSS2-28”, manufactured by NIIGATA MACHINE TECHNO CO., LTD.). Among these kneaders, a high shear molding machine equipped with a feedback screw is particularly preferable.

Melt-kneading may be performed by mixing a liquid crystal polyester, a nanostructured hollow-carbon material and, optionally, other components in advance using mixers such as a Henschel mixer and a tumbler, and then feeding this mixture to a kneader. In the case of using other components, a liquid crystal polyester may be mixed in advance with a nanostructured hollow-carbon material, and then this mixture and other components may be separately fed to a kneader. From the viewpoint of an easy treatment, a liquid crystal polyester, a nanostructured hollow-carbon material and, optionally, other components may be melt-kneaded under low shear using a conventional extruder and pelletized, and then the obtained pellets may be melt-kneading under high shear rate of 1,000 to 9,000/second in the same manner as described above.

The liquid crystal polyester composition obtained by the present invention can be suitably used as a molding material for the production of various molded bodies. Various methods capable of melting, forming and solidifying a resin can be employed as a molding method, and examples thereof include an extrusion molding method, an injection molding method and a blow molding method. Among these methods, an injection molding method is preferable. The obtained molded body may be further processed by means such as curing or press.

Examples of the molded body include carriers such as a wafer carrier, an IC chip carrier, a liquid crystal panel carrier, a HD carrier, an MR head carrier, a GMR head carrier, and a VCM carrier of HDD; charging members such as a charging roll, a charging belt, a discharging belt, a transfer roll, a transfer belt and a developing roll in image forming apparatuses such as an electrophotographic copier and a electrostatic storage device; and components of a device which transports paper such as bill. As used herein, “carrier” means a container- or tray-shaped carrier used for transportation of products such as various members and articles.

### EXAMPLES

The present invention will be described below by way of Examples, but the present invention is not limited to these Examples. Flow initiation temperature of a liquid crystal polyester, and specific volume resistance value and tensile strength of a molded body were respectively measured by the following procedures.

### 1. Flow Initiation Temperature of Liquid Crystal Polyester

Using a flow tester (Model CFT-500, manufactured by Shimadzu Corporation), a flow initiation temperature was measured by the following procedure. That is, about 2 g of a liquid crystal polyester was filled in a cylinder with a die including a nozzle having an inner diameter 1 mm and a length of 10 mm attached thereto, and the liquid crystal polyester was extruded through the nozzle while melting at a rate of 4° C./minute under a load of 9.8 MPa (100 kgf/cm²), and then the temperature at which the liquid crystal polyester shows a viscosity of 4,800 Pa·s (48,000 poise) was measured. This temperature was regarded as a flow initiation temperature.

### 2. Specific Volume Resistance Value of Molded Body

Using Digital Super Megohm/Microscopic current measuring meter DSM-8104, manufactured by DKK-TOA CORPORATION, a specific volume resistance value at a measurement temperature of 23° C. was determined by a specific volume resistance measuring method in accordance with ASTM D257.

### 3. Tensile Strength of Molded Body

The tensile strength of the molded body was measured in accordance with ASTM D638.

### Production Example 1

### Production of Liquid Crystal Polyester

In a reactor equipped with a stirrer, a torque meter, a nitrogen gas introducing tube, a thermometer and a reflux condenser, 994.5 g (7.2 mol) of p-hydroxybenzoic acid, 299.1 g (1.8 mol) of terephthalic acid, 99.7 g (0.6 mol) of isophthalic acid, 446.9 g (2.4 mol) of 4,4′-dihydroxybiphenyl, 1347.6 g (13.2 mol) of acetic anhydride and 0.2 g of 1-methylimidazole were charged and a temperature was raised from room temperature to 150° C. over 30 minutes under a nitrogen gas flow while stirring, and then the mixture was refluxed at 150° C. for 1 hour. Then, 0.9 g of 1-methylimidazole was further added and the temperature was raised from 150° C. to 320° C. over 2 hours and 50 minutes while distilling off the by-produced acetic acid and the unreacted acetic anhydride. After maintaining at 320° C. until an increase in torque was recognized, contents were taken out from the reactor and then cooled to room temperature. The obtained solid substance was ground by a grinder to obtain a powdered prepolymer. Then, the temperature of this prepolymer was raised from room temperature to 250° C. over 1 hour under a nitrogen gas atmosphere, raised from 250° C. to 285° C. over 5 hours and the solid phase polymerization was performed by maintaining at 285° C. for 3 hours, followed by cooling to obtain a powdered liquid crystal polyester. A flow initiation temperature of this liquid crystal polyester was 327° C.

### Production Example 2

### Production of Nanostructured Hollow-Carbon Material

Using 2.24 g of an iron powder, 7.70 g of citric acid and 400 ml of water, an iron mixed solution having the concentration of 0.1 M (M represents mol/l) was prepared and this iron mixed solution was charged in a closed container and then mixed by a desktop shaker for 7 days. During a period of mixing, the generated hydrogen gas was appropriately discharged from the container to obtain a template catalyst nanoparticle mixed solution. To the mixed solution of 6.10 g of resorcinol and 9.0 g of formaldehyde, 100 ml of the template catalyst nanoparticle mixed solution was added and 30 ml of an aqueous ammonia solution was added dropwise while vigorously stirring. The pH of the obtained suspension was 10.26. The suspension was polymerized for 3.5 hours by heating to a temperature of 80 to 90° C. on an oil bath to produce a carbon material intermediate. The obtained carbon material intermediate was recovered by filtration, dried overnight in an oven and then fired in a nitrogen atmosphere at 1150° C. for 3 hours. The obtained nanostructured composite material was refluxed by a 5M nitric acid solution for 6 to 8 hours and then subjected to a heat treatment in 300 ml of an oxidizing mixed solution (H₂O/H₂SO₄/KMnO₄=1/0.01/0.003 (molar ratio)) at 90° C. for 3 hours. After washing with water and drying in an oven for 3 hours, 1.1 g of a nanostructured hollow-carbon material was obtained.

### Production Example 3

### Production of Liquid Crystal Polyester Composition 1a for Raw Material

After mixing 94 parts by mass of the liquid crystal polyester obtained in Production Example 1 with 6 parts by mass of the nanostructured hollow-carbon material obtained in Production Example 2 by a Henschel mixer, the obtained mixture was kneaded and granulated at a cylinder temperature of 340° C. under shear rate of 100/second using a twin screw extruder PCM-30 manufactured by Ikegai Iron Works, Ltd. to obtain a liquid crystal polyester composition 1a for a raw material. The liquid crystal polyester composition 1a for a raw material was used as a raw material for the production of the liquid crystal polyester composition according to the present invention in Example 1.

### Production Example 4

### Production of Liquid Crystal Polyester Composition 2a for Raw Material

In the same manner as in Production Example 3, except that the use amount of 94 parts by mass of the liquid crystal polyester was changed to 96 parts by weight and the use amount of 6 parts by mass of the nanostructured hollow-carbon material was changed to 4 parts by mass, a liquid crystal polyester composition 2a for a raw material was obtained. The liquid crystal polyester composition 2a for a raw material was used as a raw material for the production of the liquid crystal polyester composition according to the present invention in Example 2.

### Example 1

A liquid crystal polyester composition 1a for a raw material was (i) put in a high-shear molding machine equipped with a feedback screw, NHSS2-28, manufactured by NIIGATA MACHINE TECHNO CO., LTD., (ii) heat-melted at a gap of 2 mm, a plasticizing portion temperature of 300° C. and a kneading portion temperature of 320° C., (iii) kneaded at a screw rotation of 2,000 rpm under shear rate of 4,400/second for 30 seconds, and then (iv) extruded through a T-die to obtain a liquid crystal polyester composition 1 for molding according to the present invention. In that case, (a) a diameter of the feedback screw, (b) an inner diameter of the screw feedbacking portion, and (c) a gap between the screw head and a cylinder of the molding machine were adjusted at 28 mm, 2.5 mm and 2 mm, respectively. Also, in order to reduce generation of shear heat, the temperature was controlled using a cooling mechanism so that the temperature of a kneading portion was not higher 360° C.

The obtained liquid crystal polyester composition 1 for molding was press-molded under the conditions at 340° C. under 100 Mpa using a press machine NP-37 manufactured by SHINTO Metal Industries Corporation to obtain a molded body measuring 50 mm×50 mm×3 mmt, and then a specific volume resistance value of the molded body was measured. The liquid crystal polyester composition 1 for molding was subjected to injection molding under the conditions of a cylinder temperature of 340° C. and a mold temperature of 150° C. using Hand Truder PM-1 manufactured by Toyo Seiki Co., Ltd. to obtain a 2 mm thick JIS 7113 No. 1(1/2) dumbbell and then a tensile strength thereof was measured. The results are shown in Table 1.

### Example 2

In the same manner as in Example 1, except that the liquid crystal polyester composition 1a for a raw material was changed to the liquid crystal polyester composition 2a for a raw material, a liquid crystal polyester composition 2 for molding according to the present invention, a molded body for the measurement of a specific volume resistance value, and a dumbbell for the measurement of a tensile strength were produced. The results are shown in Table 1.

### Comparative Example 1

The liquid crystal polyester composition 1a for a raw material was press-molded under the conditions at 340° C. under 100 MPa using a press machine MP-37 manufactured by SHINTO Metal Industries Corporation to obtain a molded body measuring 50 mm×50 mm×3 mmt and then a specific volume resistance value thereof was measured. The liquid crystal polyester composition 1a was subjected to injection molding under the conditions of a cylinder temperature of 340° C. and a mold temperature of 150° C. using Hand Truder PM-1 manufactured by Toyo Seiki Co., Ltd. to obtain a 2 mm thick JIS 7113 No. 1(1/2) dumbbell, and then a tensile strength thereof was measured. The results are shown in Table 1.

### Comparative Example 2

In the same manner as in Comparative Example 1, except that the liquid crystal polyester composition 1a for a raw material was changed to the liquid crystal polyester composition 2a for a raw material, a molded body for the measurement of a specific volume resistance value and a dumbbell for the measurement of a tensile strength were produced. The results are shown in Table 1.

TABLE 1

| | Liquid crystal | | Molding | |
|---|---|---|---|---|
| | polyester composition | | Specific volume | Tensile |
| | For raw | For | resistance | strength |
| | material | molding | value (Ω · m) | (MPa) |
| Example 1 | 1a | 1 | 1.2 × 10¹⁰ | 136 |
| Example 2 | 2a | 2 | 4.4 × 10¹¹ | 137 |
| Comparative | 1a | 1a | 1.0 × 10¹⁴ | 121 |
| Example 1 | | | | |
| Comparative | 2a | 2a | 1.0 × 10¹⁵ | 120 |
| Example 2 | | | | |

As is apparent from the above results, it could be confirmed that the molded bodies of Examples have semiconductivity and are excellent in mechanical strength as compared with the molded bodies of Comparative Examples.

The liquid crystal polyester composition according to the present invention is usable in the filed of resin molded bodies having semiconductivity such as resin molded bodies to which performances such as antistatic properties and dust adsorption preventing properties are required.

What is claimed is:

1. A method for producing a liquid crystal polyester composition comprising a liquid crystal polyester and a nanostructured hollow-carbon material which satisfies the following requirement (A), the method comprising the step of melt-kneading a liquid crystal polyester in the amount of 85 to 99 parts by mass and a nanostructured hollow-carbon material in the amount of 1 to 15 parts by mass, based on 100 parts by mass in total of the liquid crystal polyester and the nanostructured hollow-carbon material, under shear rate of 1,000 to 9,000/second:
(A) the nanostructured hollow-carbon material includes a carbon part and a hollow part, and has such a structure that a part or all of the hollow part is surrounded by the carbon part.

2. The method for producing a liquid crystal polyester composition according to claim 1, wherein the carbon part of the nanostructured hollow-carbon material has a thickness of 1 to 100 nm and the hollow part has a diameter of 0.5 to 90 nm.

3. The method for producing a liquid crystal polyester composition according to claim 1, wherein the nanostructured hollow-carbon material is a material produced by a method comprising the following steps (1), (2), (3) and (4) in this order:
(1) step of producing template catalyst nanoparticles;
(2) step of polymerizing a carbon material precursor in the presence of template catalyst nanoparticles to form a carbon material intermediate on a surface of template catalyst nanoparticles;
(3) step of carbonizing the carbon material intermediate formed on the surface of template catalyst nanoparticles to produce a nanostructured composite material; and
(4) step of removing template catalyst nanoparticles from the nanostructured composite material to produce a nanostructured hollow-carbon material.

4. The method for producing a liquid crystal polyester composition according to claim 1, wherein melt-kneading is carried out by a shear molding machine equipped with a feedback screw.
